(19) United States
(12) Patent Application Publication
(10) Pub. No.: US 2013/0003126 A1
(43) Pub. Date: Jan. 3, 2013

(54) METHOD AND SYSTEM FOR PROVIDING A PRINTING WEB SERVICE

(76) Inventors: Brian Van Osdol, Menlo Park, CA (US); Angela Cheung, Menlo Park, CA (US)

(21) Appl. No.: 13/539,503

(22) Filed: Jul. 2, 2012

Related U.S. Application Data
(60) Provisional application No. 61/503,486, filed on Jun. 30, 2011.

(51) Int. Cl. G06K 15/02

(52) U.S. Cl. 358/1.15

(57) ABSTRACT

A method and system of a preferred embodiment includes configuring a print queue of a user at a web service; collecting image media of the user; adding collected image media to the print queue; identifying a satisfied print condition; and creating a deliverable print package upon identifying a satisfying print condition. In another embodiment a method and system of a preferred embodiment includes receiving a media file; receiving parameter settings of an embeddable version of the media file; creating an embeddable version of the media file with the parameter settings; receiving a purchase command through the embeddable version; and delivering media to a user associated with the received purchase command.

### CROSS-REFERENCE TO RELATED APPLICATIONS

This application claims the benefit of U.S. Provisional Application No. 61/503,486, titled “METHOD AND SYSTEM FOR PROVIDING A PRINTING WEB SERVICE”, and filed 30 Jun. 2011, which is incorporated in its entirety by this reference.

### TECHNICAL FIELD

This invention relates generally to the photo and image field, and more specifically to a new and useful method and system for providing a printing web service in the photo and image field.

### BACKGROUND

Digital cameras have drastically altered the way people use photographs. People now have photographs in a myriad of various locations. People store photographs on memory cards in digital cameras, phones, laptops, desktop computers, tablets, TV computing systems, and other devices. Similarly there are numerous web services to aid in the collection of photographs. However, one problem with digital photographs is that people can easily lose track of them over time. Device failures, updating to a new device, pure data saturation (difficult to search old images), images spread to a variety of services and storage systems are just some of the reasons people can't find old photos. While today we have more ways than ever to capture and record our lives, these new offerings actually work to reduce the particular benefits of photographs. Digital photo saturation is so great that typically people only interact with photos recently taken. Physical photographs are a well-proven solution to preserving memories and images. But printing photographs is burdensome in the digital age of photographs. Transferring photographs to one storage system is already one hurdle for users, and then to afterwards filter photographs and order prints renders the barrier to printing photos too great for it to be a frequently done. Similarly, a printed photograph lacks many of the benefits of a digital photo.

A related problem exists with people and entities wanting to distribute their work to others. Many blogs, social networks, and digital image sharing sites allow people to comment and favorite images, and this sharing of artwork and photographs with others has been tremendous in sharing talents with others. However, artists often receive little in exchange for their labors other than the pride of providing so many people with the enjoyment of their digital artwork. Even if an artist attempts to capitalize on their artworks by selling prints, there are many barriers to hamper such efforts. First off, a user must typically leave the page where the piece was originally encountered (such as on a blog post) and go to an online store. Additionally, as the image is shared on the internet, sometimes without attribution to the artist, finding the online store to purchase the image can be challenging if not impossible. Thus, there is a need in the photo and image field to create a new and useful method and system for providing a printing web service. This invention provides such a new and useful method and system

### BRIEF DESCRIPTION OF THE FIGURES

FIG. 1 is a schematic representation of a method for providing a printing web service of a first preferred embodiment;

FIGS. 2A and 2B are exemplary representations of a frontside and a backside of a print of a preferred embodiment;

FIG. 3 is a schematic representation of a method for distributing content for a printing web service of a second preferred embodiment;

FIGS. 4A-4C are exemplary screenshots of an embeddable version of an image; and

FIG. 5 is a schematic representation of a system of a preferred embodiment of the invention.

### DESCRIPTION OF THE PREFERRED EMBODIMENTS

The following description of the preferred embodiments of the invention is not intended to limit the invention to these preferred embodiments, but rather to enable any person skilled in the art to make and use this invention.

### 1. Method for Providing a Printing Web Service

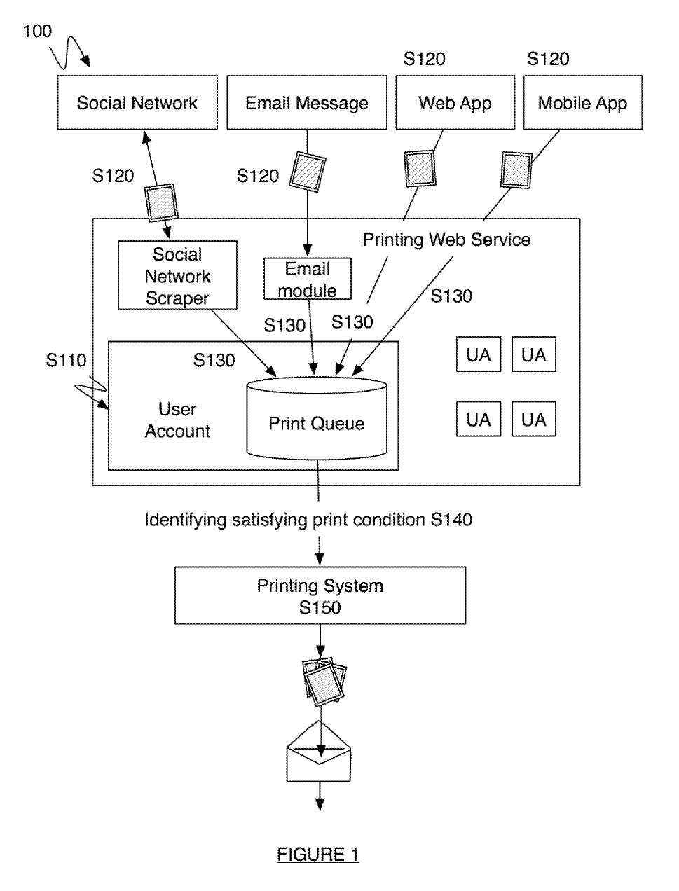

As shown in FIG. 1, a method 100 for providing a printing web service of a first embodiment preferably includes configuring a print queue S100, collecting image media S120, adding image media to the print queue S130, identifying a satisfying print condition S140, and creating a print package upon identifying a satisfying print condition S150. The method functions to provide a distributed printing interaction that reduces barriers to obtaining printed images. The method preferably enables photographs and other images to be printed from a wide variety of sources. Furthermore, the printing service functions to create a user experience that requires minimal or little effort on the part of the user to print photos as they use digital photos in a typical fashion. The printing of photos is preferably coordinated to auto batching photos for printing and delivery to a user. To the user this significantly reduces the barrier to printing any given image by allowing users to offload the act of grouping photos for print to the system. The method may additionally be used to create tangible/physical versions of various forms of digital media. Additionally, in one preferred embodiment supplemental media may be printed to the backside of a physical printed image or attached to a physical printed image. The supplemental media (or printed metadata) may allow for a combination of unique features that can integrate the digital print features and physical prints. The printing web service additionally functions to alleviate end users of the task of maintaining photo quality printers when they use the printing as service features of the printing web service. The method is preferably facilitated by a hosted web service with communication channels to at least one image input stream. The method may additionally include a printing web interface, desktop and/or mobile application, social network scraping engine, social network API interface, and other suitable components for providing inputs to the web service. The printing web service additionally preferably communicates with a print production system that prints and prepares shipments of prints. In one application of the method, a user can preferably upload images to the service at convenient times. Preferably, the user will upload a photo soon after taking the photo. The photo is added to a print queue. When the print queue is full or the queue is due to be printed, the images in the queue are printed, packaged, and sent to the user. Thus, the user can prepare photos for printing in an asynchronous manner, adding photos when it is convenient. The method may alternatively be applied in any suitable manner. While the method focuses on the preferred variation of printing images, the method is not limited to images and may be applied to documents, video, music, 3D objects, and any suitable media that may be converted to a physical object.

Step S110, which includes configuring a print queue, functions to setup a print queue for a user. A print queue preferably stores images until the images of the print queue may be printed and shipped to the user in a group. The print queue is preferably configured to be used by a single user, but may alternatively be a print queue shared by a plurality of users. The print queue preferably exists in a hosted database managed by a web service. The print queue may alternatively be a locally stored list of photos in the queue such as in a database of a native application. The print queue may alternatively be any suitable data storage model to manage a group of images for printing, such as a tagging architecture. Preferably, a user has an account with the printing web service or in an application and some settings may be stored for the print queue. Preferably a user provides a destination for the prints generated from the print queue. The destination is preferably a postal address, but may be any suitable address such as a name for pickup at a store. The destination is typically the postal address for the user creating the photos but may alternatively be a postal address for another entity. Additionally, a plurality of addresses may be added such that copies of a print package may be delivered to multiple destinations. Additionally, a user may select print conditions for the print queue. The creation of a print package may be triggered when a number of photos are added to the print queue, after a period of time has passed (measured from creation of the print queue, the first added photo to the print queue, or by any suitable standard), by a user command to deliver the print package, a combination of conditions, or during any suitable print condition. Preferably, the group of printed photos is limited to the number of photos that fit within an envelope. Preferably, a group of photos from the print queue are shipped through a standard envelope, and thus the group of photos may have a maximum number of photos of ten to twenty, but any suitable number of photos may be used as a maximum threshold. Thus, triggering the printing from the print queue may additionally be linked to size restrictions of a print package.

A print queue is preferably setup after a user provides payment for the print queue. Payment may alternatively occur at any suitable time such as when creating the print package. A print queue is preferably individually purchased. In this variation, once the images in a print queue are printed and shipped, the print queue is no longer available until another print queue is purchased. Alternatively, multiple print packages may be sent as part of a package. Alternatively, a print queue may be provided as part of a user subscription to the printing service. As additional alternatives, the user may agree to have advertisements printed along with the prints, or the user may participate in an advertisement session in exchange for prints. As yet another alternative, the print queue may be earned or provided for free. Preferably, payment information such as a credit card is stored such that future print queues and additional print fees may be facilitated without repeated entry of payment information.

Step S120, which includes collecting image media S120, functions to gather photos from the user that should be printed in the next print package. Image media preferably includes photographs and images but may alternatively or additionally include any suitable media. Illustrations, and graphics are preferably treated in a similar manner as images. Documents, video, music, and other various media formats may additionally be collected. An image representation is preferably created for such non-static image media. A document may have a snapshot of the first page created. A video may have a frame or mosaic of frames of the video selected as the image representation. Music may have the meta data from the music file used as the images (such as the artist name, song title, album cover). These various formats may have supplemental media printed along with the image that links the physical print to the digital version of the media. In one preferred embodiment, the print queue is hosted on a print web service. The print web service preferably enables a plurality of sources to add to the print queue.

In another embodiment, the image media is collected locally from a native application on a phone, digital camera, or other device. Some sources of image media may include email, social media messages, website uploads, photo hosting sites, device photo gallery, mobile application, MMS (multimedia messaging service) messages, embeddable versions of an image (as described below), and/or any suitable source of media. An email account may be setup for the particular account so that sending an email with an image attachment will add the attached image(s) to the print queue. Step S120 may additionally include scraping social media streams or accessing Social media content via an API to retrieve user indicated photos. All Links to photos or hosted photos that are included in a social media message may be added. Additionally, a message indicator may be used to determine which messages to process to add any included photos. For example, messages including a particular hashtag may have any linked images added to the print queue. From a native application, images may be directly added to a print queue, or may be added to a print queue while simultaneously sharing through any suitable social media network. Sources of photos are preferably periodically scraped for new image media. Image metadata is additionally preferably collected for use as supplemental media. Photo metadata may include a caption, title, date, location. Photo metadata may be supplied directly from the user, or the metadata may be inferred based on the medium in which the image media is obtained. For an email, text found in the subject and body of an email is preferably used as a caption. In a social media message, the social media message is added as the caption in the supplemental media. The image media is preferably collected asynchronously. In that adding a photos to a print queue preferably does not need to occur at the same time or sequentially. For example, a user may upload one photo through a native application on one day. Then, days later, add another photo by attaching the image in a social media post. Then yet another photo may be added by including an image in an email sent to a plurality of contacts one being associated with the print queue of the user. The asynchronous functionality of the print queue and the types and variety of inputs preferably functions to make the user selection of images for printing a less taxing experience.

Additionally images may be added based on actions of other users. Preferably images may be added to a print queue based on social network interactions of a second user. Social network interactions may include tagging the user in a image media or in a caption for image media. Additionally or alternatively, a user may configure their account to subscribe to at least a second user or join a group of a plurality of users. Image media generated from the second user or from the group may be automatically added to the print queue of the user. As another variation, a second user may gift image media to the user, and the gifted image media may be added to the print queue for efficient delivery.

Step S130, which includes adding image media to the print queue, functions to add the images to a group of images awaiting printing. As long as there is room in the print queue, an image is preferably added to the print queue. Preferably, the print queue is not limited in number of image. If a print condition is satisfied and there are still images to be added, then at least a subset of the images are preferably selected for printing. Images preferably remain in the print queue until they have been selected for printing. Image media may be asynchronously added to the print queue. In other words, images may be added at any suitable time, and preferably do not need to be added in a single upload.

Step S140, which includes identifying a satisfying print condition, functions to determine when the print queue is ready for printing. Preferably, the print condition is based on a threshold for the number of images in the print queue. In one variation, the threshold a value in the range of 10 to 20 images, but any suitable number may be used. When the print queue reaches the threshold value, the creation of a deliverable print package is preferably initiated. In another variation, the print queue is time based. Images from the print queue may be printed every week, two weeks, month, or after any suitable time period. In another variation, the print condition may include a plurality of conditions. For example, the print condition may be satisfied if the print queue passes an image count threshold or if it has been two weeks since the first image was added to the print queue. Additionally, a user-initiated command may be used to initiate the creation of a print package. An option in a user interface is preferably provided to a user to request the photos to be sent. A user-initiated command preferably supersedes other print conditions. The print conditions are preferably checked each time a photo is added to a print queue and/or at a scheduled time as part of a background process, but may alternatively be checked at any suitable time. Preferably images are selected for printing based on the time they were added to the print queue. As another variation, a identifying a satisfying print condition may include selecting images from the print queue for printing. Selection of images may be based on any number of inputs such as social media activity. For example, if a particular image was liked, commented on, received a high rating, and/or had any suitable social network interaction signifying the image was of significance then the image may be selected for printing.

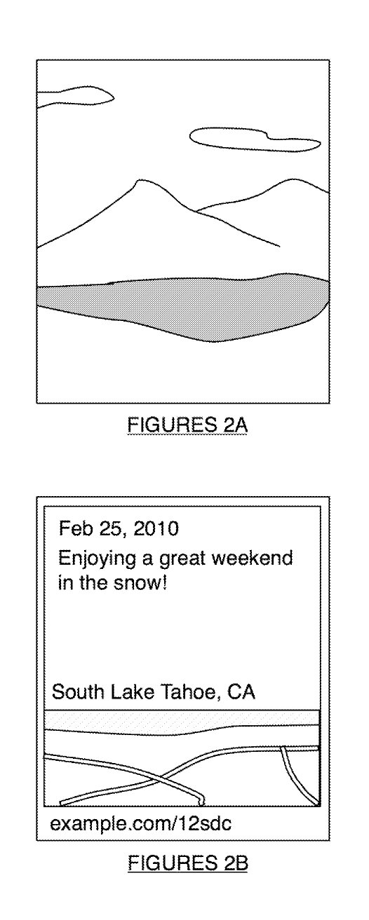

Step S150, which includes creating a print package upon identifying a satisfying print condition, functions to print and package images from the print queue. Preferably the creation of a deliverable print package is at a remote printing facility. Alternatively, the creation of a deliverable print package may be at one of a plurality of distributed local print facilities. The distributed local print facilities preferably have a printing system configured to receive print orders. The distributed local print facilities preferably function to facilitate faster shipping times by printing closer to the destination of the print package. In the local print facility variation, the geographic location data of the user may be received (such as GPS position from a mobile phone or tablet), and a local print facility identified. In this variation, a user can receive prints without being near their shipping address (e.g., while on vacation). A print order is preferably created from the print queue. This print order may be added to a plurality of other print orders since the printing facility is managing the printing of images for a plurality of users. The images are preferably printed and receive any additional preparation (e.g., cutting, embossing, coating etc). Additionally, the images preferably have double sided printing. On one side an image is preferably printed as shown in FIG. 2A. On the opposite side of paper, supplemental media is preferably printed. In one example, a caption, image date, photo location name, and a map associated with the image is preferably printed as shown in FIG. 2B. Additionally, a digital link is preferably printed on the back of the image. The digital link may be a URI (universal resource identifier), a QR code, a visual encoding of a URI, a code, a media ID, or any suitable addressing mechanism. The digital link is preferably a reference to a digitally hosted version of the image. At the digitally hosted version of the image new prints may be obtained, comments may be recorded, and any other digital image related interactions may occur. For other non-image forms of media, the digital link preferably can be used to direct users to the digital version of that media. For example, for an image from video media will preferably include a digital link to a playable version of the video. The supplemental media may alternatively or additionally be printed on the front side of the printed image or at any suitable location. Additionally other print formats may be prepared such as photo books, fold-out folios, cards, calendars, other paper mediums, or any suitable products. In another variation, the printing may be a 3D object or any suitable dynamically generated object. An envelope or package is preferably printed with the destination address of the photo queue. The photos are manually or automatically added to the envelope or package and sent for delivery. The generation of a plurality of deliverable print packages may additionally be optimized for postal efficiency such as by ordering daily printing by zipcode or any suitable optimization. If multiple destination addresses are included for the print queue then the corresponding number of print packages is preferably created. After a print queue is printed, the images of the print queue are preferably removed from the print queue and preferably added to a digital photo gallery on the user account. The print queue may additionally be removed from the account if the print queue was a single use print queue. Each individual image additionally is preferably hosted at an individual URI. The optional digital link printed on the photo preferably directs users to the individual URI.

### 2. a Method for Distributing Content for a Printing Web Service

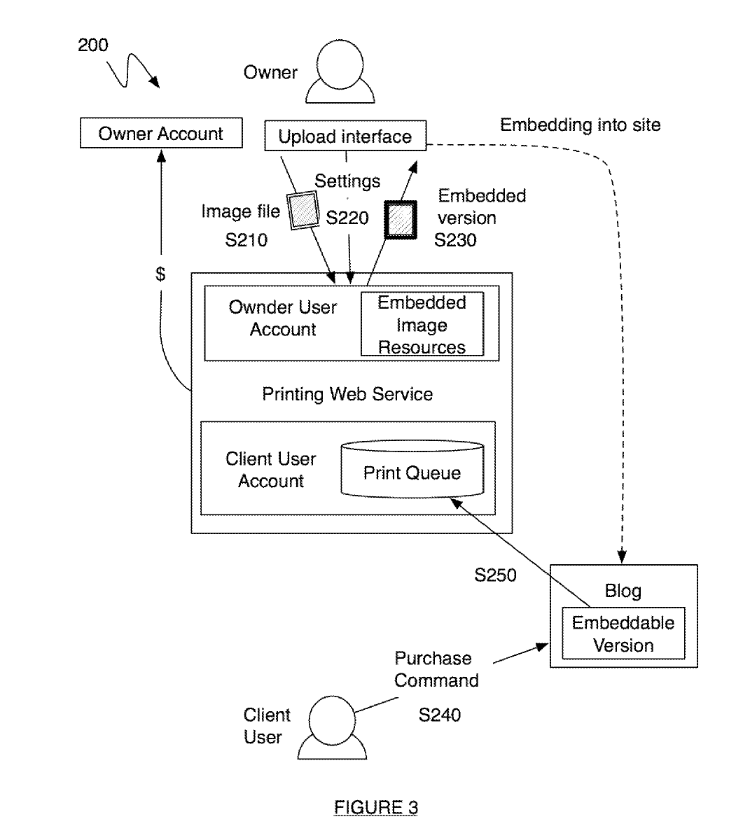

As shown in FIG. 3, a method 200 for distributing content for a printing web service of a preferred embodiment includes receiving an image file S210, receiving parameter settings of an embeddable version of the image S220, creating the embeddable version of image with the parameter settings S230, the embeddable version receiving a purchase command from the a client user S240, and adding the image associated with the embeddable version to a print queue of the client user S250. The method functions to provide a way to distribute media for purchase. More preferably, the method functions to provide a way to distribute images for print in a useful and nonintrusive manner. The embeddable version of the image is preferably a web markup that can be inserted into a webpage where the image is displayed substantially similar to an image, but with an additional purchase user interface. The method can preferably enable photographers, illustrators, artists, writers, bloggers, and other entrepreneurial entities to sell media directly from where the media is used. In one exemplary application, an illustrator may have a blog where they often post images. The blog may be very popular, but the illustrator probably receives little in return for the artwork they produce. Using a system implementing the method 200, the illustrator can upload artwork to the service, create an embeddable version of the image, and post the embeddable version instead of a standard image files. A plugin can preferably be implemented to stream line these steps for the user. The viewers of the blog will experience substantially the same experience since the embedded version appears as an image on the blog, except that if the viewer likes the image, the user can quickly purchase a print of the image preferably avoiding the tedious steps often encountered in an ordering process. The prints are delivered to the client, and optionally funds are transferred to the account of the artist. The artist in return does not have to deal with orders, printing, and shipping. Additionally, as the embeddable version is shared across the web, the original author can still financially benefit and/or retain control over the usage of the image. The method is preferably implemented with a hosted printing web service and a printing system. The hosted printing web service preferably facilitates managing interactions with the embeddable versions, and the print queues associated with users. The printing web service is preferably substantially similar to the printing web service implementing the method 100 described above, but may alternatively be any suitable web service with any suitable printing process. In another variation the web service facilitates access to media content as opposed to producing prints. Additionally, a web service that specializes in digital collections or any suitable web service may be used in place of the printing web service to implement embeddable versions of images, video, multimedia, articles or any suitable media.

Step S210, which includes receiving an image file S210, functions to obtain an uploaded image or media file from a user. The image file is preferably a standard image files such as a jpeg, png, tiff, gif, or any suitable image file. The user may alternatively supply a link to an internet accessible image or media file. The user preferably uploads the image file from a web application of the printing web service. The user may alternatively use an application or any suitable portal. An image may be received using any of suitable alternative such as the various techniques described above in method 100. Alternatively, an image from a social network or other image-hosting site may be selected. A plurality of image files may additionally be received. An embeddable version may be created for each image. An embeddable gallery of individually purchasable images may be created from the plurality of images. Alternatively, a group print package may be offered from the plurality of images. For example, a flipbook or folio may be created from the plurality of images. Additionally or alternatively, other non-image media formats may be used such as video, music, or documents. An image representation of the media format may be created. For non-image media, the original version of the media is preferably presented in the embeddable version, but an image representation is preferably used for any printing. A print of non-image media is preferably accompanied with a digital link to the site associated with the non-image media. The received image file is preferably added to an account of the user. The user account preferably includes suitable information to complete the method. For example, a financial account such as a credit card number or banking account information is preferably stored. The financial account preferably enables payment received for purchased images to be delivered to the owner.

An original creator or an entity authorized to sell or distribute the image (e.g., copyright holder) preferably uploads the image file. The user distributed the content is referred to as the owner in this document. Step S210 may additionally include authorizing image for user distribution. This sub-step preferably includes a user expressing ownership and rights to distribute the image. Additionally, the media file may be analyzed for satisfying criteria that indicate the media file is owned by the uploader of the media. For example, a minimum image size may be required. It is typically more likely that an owner of an image has a high-resolution version of an image. A high resolution preferably requires the image to have a pixel dimension such as greater than 1280 by 1024 pixels. Additionally, an image based search may be performed to identify any identical or substantially similar images stored internally in the printing web service or found elsewhere on the internet. Additionally, if the user desires to do limited prints then, the images previously uploaded for distribution may be searched to identify reprinting of the same image. If an image matching the current upload is identified then the distribution of that image and/or the distribution of the found image may enter an ownership-conflict state. Determining the ownership may be resolved in any suitable manner.

Step S220, which includes receiving parameter settings of an embeddable version of the image, functions to set options of the embeddable version of the image file. Parameter settings preferably include the price of the image. The price may alternatively be set by default for all images. Other purchase options may include medium to be used for the printed. For example, the size of the print, the paper type, or object type may be printed. The object type may be any suitable type of object where an image may be applied. In one variation, a plurality of images may be configured for printing on one object such as in a book. Additionally, one preferred embodiment prints supplementary media with an image. The metadata may additionally be supplied by the owner such as a description, time, author name, location, and/or any suitable metadata. Additionally usage rights may be selected for being printed along with the metadata such as a creative commons license for the image. Additionally, the owner may add formatted content, preferably web formatted content using HTML and CSS. The HTML content may be used such that printing of supplementary media can be customized by the owner. In one variation, using web formatting enables a client user to customize the supplementary content. For example, the formatted content may have text entry field, and or a user interface for a client user to set the supplemented media that will be printed with the image. Preferably the formatted media has a fixed size limit such that the formatted content satisfies the specifications of the print medium (e.g., print dimensions, color restrictions, etc.). The parameter settings may additionally include settings for the display and functionality of the embeddable. The owner can preferably customize background colors, menu display options, size of the embeddable, and any suitable aspect of the display of the embeddable. Parameter settings may alternatively be set by default, and an owner has no input into the settings of an embeddable version of the image.

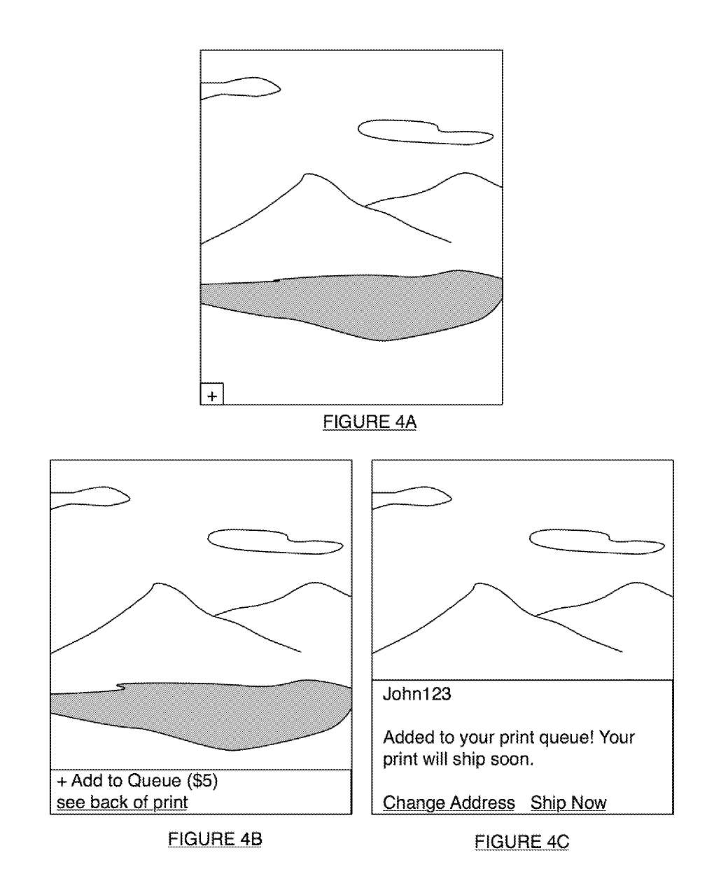

Step S230, which includes creating the embeddable version of image with the parameter settings, functions to generate a code or a media file that a user can share and/or use. Preferably web resources for the embeddable are created within the printing web service (e.g., saving the image file, creating a dedicated webpage), and code is produced that the owner may copy and use within a blog or website. The code is preferably HTML using an iframe, div tag, canvas tag, and/or any suitable markup to wrap the image. Additionally, the embeddable version preferably includes a script (e.g., javascript code) to provide any dynamic functionality. One preferred application of the script is to dynamically load the iframe content while passing the site origin as a URI parameter. For example, the URI where the embeddable version is encountered is preferably included as a parameter of the URI loaded into the iframe. Other aspects of the origin site such as a post title, post comments, and other parameters may additionally be passed to the embeddable version. The origin-based parameters may alternatively be obtained in any suitable manner. Alternatively, a file may be created such as a flash file, a java applet, or any suitable embeddable file. In another alternative an application object may be created that can be used within an application or platform such as a social network page. As shown in FIG. 4A, an embeddable version preferably includes the associated image, predominately displayed, and a purchase menu interface. The purchase menu interface preferably is statically indicated by a small graphic. When user interacts with the embeddable version (hovering a mouse over the image, tapping the image, giving the image focus) the purchase menu interface preferably expands to reveal options as shown in FIG. 4B. The purchase menu interface may alternatively remain substantially constant until a purchase command is received. The client user can preferably select any options available for the embeddable version such as printing options including medium, size, and/or supplemental media content. Preferably, a purchase button (or any suitable UI element) is displayed within the purchase menu interface. The embeddable version preferably includes any logic to enable the full purchase experience within the embeddable version. Alternatively, selecting a purchase button may direct a client user to a purchase site. Sharing options may additionally be provided through the purchase menu interface. Sharing options may include emailing or sharing over a social network a link to the site or to the URI of the embeddable version. Sharing options may additionally include providing the embeddable version of the image (e.g., HTML code). As the distribution of the image uses the embeddable version, where the embeddable version is posted does not matter. The owner preferably receives payment regardless of who and where the embeddable version is used. Thus, an owner may benefit from other users posting the embeddable version on other sites.

Step S24o, which includes the embeddable version receiving a purchase command from the client user, functions to initiate the purchase of an image by a client user. A client user is preferably any suitable user accessing a site with the embeddable version. The client user may be using any suitable device to access the site or application. When the user activates the purchase button, a confirmation screen is preferably displayed as shown in FIG. 4C. If the user is signed in, as indicated by a cookie or any suitable mechanism, a simple confirmation screen is preferably displayed. In one variation, the confirmation screen displays how many photos are left in the print queue, and notes the charge (if any) that will be made to the account. If the user is not signed in, then the client user may be prompted to signup and/or create an instant account. The instance account may be created by supplying the client with a code for future retrieval of the image, by retrieving information such as an email address, or through any suitable way. Additionally, a dedicated webpage may be created for the distributed embeddable image so that a link may alternatively be used in place of an embeddable version of the image. The confirmation screen preferably automatically hides after the purchase process is complete. To the client user

Step S25o, which includes adding the image associated with the embeddable version to a print queue of the client user, functions to deliver media to a user issuing a purchase command. The print queue is preferably substantially similar to the print queue described in the method above. Each user using the printing service preferably creates an account that facilitates billing and photo delivery. This stored information is preferably used so that a user only has to enter it one time. The print queue for purchased images may alternatively be a separate queue from a print queue for user uploaded photos (i.e., personal photos). Purchased images will typically cost more, and thus, minimizing shipping cost may be less of a priority. The print queue for purchased images may have a shorter waiting period (e.g., one to two days) before being shipped. If a client user purchases several images over the course of day then those images may be packaged together, but if after two days the client user has only added one image then the single image may be sent. A purchase print queue and a personal print queue may additionally cooperatively work together. If a print package is being created and there is space in the shipment, then prints from one queue may be added to the other print package. Alternatively, the image associated with the embeddable version may be directly printed and shipped to the user. As the images added from an embeddable version may be separately purchased, the charging for purchased prints preferably occurs in bulk when the images are printed. In one variation printing of the media may be alternatively replaced or supplemented with access to media or other resources. The charging of a client user account may alternatively occur at any suitable time. Additionally, the method 200 may include transferring funds to the owner, which functions to pay the owner for sold media. Preferably, a portion of the price of an image goes into shipping, a portion goes to printing and the service of the printing web service, and a portion goes to the owner. Additionally, a portion may go to affiliates that promote the site or to any suitable entity. The transferring of funds preferably occurs periodically (e.g., monthly) for the sum of all images sold. This preferably reduces transaction fees. But the transfer of funds may occur at any suitable time. In alternative embodiments the purchased media are not added to a print queue and printed, but are alternatively, added to any suitable hosting site. For example, the embeddable version may be used for purchasing digital rights to an image, or for collecting images. In this alternative embodiment, the printing web service may serve as any suitable web application/service.

The embeddable version of the image may additionally include mechanisms such that the owner retains control over the image. The image or media may be updated from a control panel on the printing web service, and this updates the image everywhere the embedded version is used. Other features that may be controlled remotely include changing pricing options, offering new print mediums, editing supplemental media associated with the image, obtaining statistics such as where the image is used, how many views it received, edit advertisements used in the image, and any suitable feature.

3. A system for a printing web service

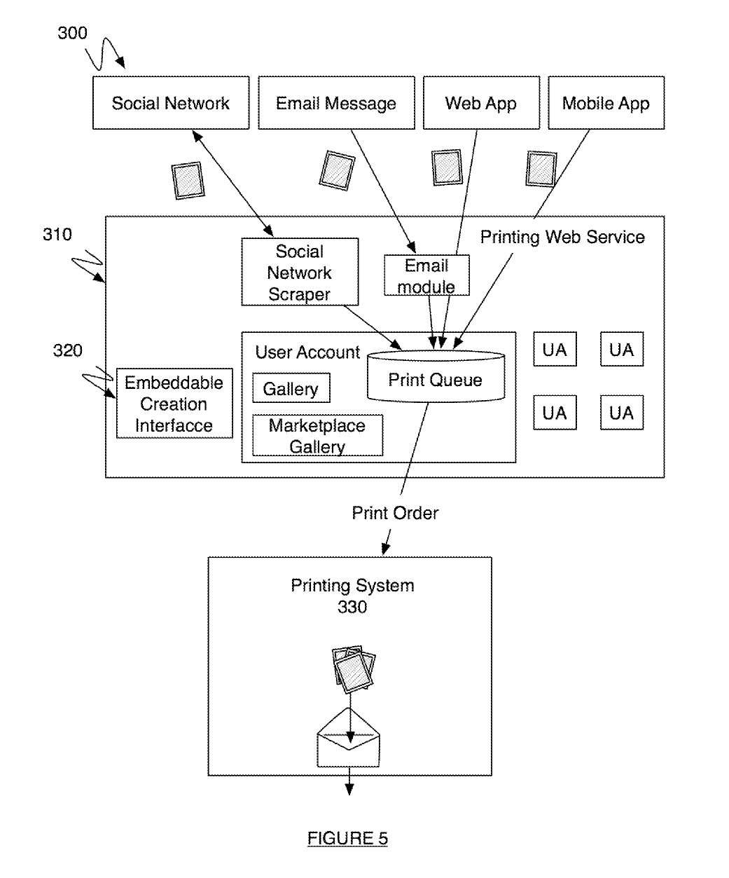

As shown in FIG. 5 a system 300 for a printing web service of a preferred embodiment includes a printing web platform 310, an embeddable creation interface 320, and a print production system 330. The system functions to provide printing as a service to a plurality of users. The printing process is preferably asynchronous, utilizing a printing queue to automatically ship the queued images based upon a print condition. The system may additionally include a mobile application, desktop application, and/or a web application that may be used to supplement adding photos to a print queue and may store the print queue directly. Additionally the printing web platform preferably includes a social network scraping engine for processing social network content for images to add to the print queue. Similarly the printing web platform may include an email module for parsing received emails for photos to add to a print queue. Any suitable module may additionally or alternatively be used to facilitate collection of media for a print queue. The printing web platform preferably hosts a plurality of accounts. An account on the printing web platform preferably includes at least one print queue, and may additionally include a gallery of previous printed images, market place images (i.e., images shared/sold through an embeddable or other mechanism), and account settings. There may additionally be a control panel for each marketplace image. Financial account information is preferably for an account such that purchases of prints and payment for purchases by others may be made. The print system 33o preferably includes at least one printer. The print system 33o preferably converts print orders to printed images and/or other products, and prepares for shipping. In one variation, the print system 33o is geographically distributed by distribution centers. Print orders are preferably processed at distribution centers closest to the destination of the print order. The printing web platform preferably produces or facilitates the creation of print orders for the print system 33o. The system preferably implements the methods described above but may alternatively perform any suitable variation or alternative steps.

An alternative embodiment preferably implements the above methods in a computer-readable medium storing computer-readable instructions. The instructions are preferably executed by computer-executable components preferably integrated with a printing web platform and/or application. The computer-readable medium may be stored on any suitable computer readable media such as RAMs, ROMs, flash memory, EEPROMs, optical devices (CD or DVD), hard drives, floppy drives, or any suitable device. The computer-executable component is preferably a processor but the instructions may alternatively or additionally be executed by any suitable dedicated hardware device.

As a person skilled in the art will recognize from the previous detailed description and from the figures and claims, modifications and changes can be made to the preferred embodiments of the invention without departing from the scope of this invention defined in the following claims.

We claim:

1. A method for printing media comprising:
configuring a print queue of a user at a web service;
collecting image media of the user;
adding collected image media to the print queue;
identifying a satisfied print condition; and
creating a deliverable print package upon identifying a satisfying print condition.

2. The method of claim 1, wherein image media includes static images and video.

3. The method of claim 1, wherein collecting image media of the user further includes collecting image media from a plurality of sources including a user upload source and a social media source.

4. The method of claim 1, wherein collecting image media of the user further includes automatically adding image media to a print queue based on social network interaction of a second user.

5. The method of claim 4, wherein a social network interaction of a second user includes the second user tagging the user in an image media.

6. The method of claim 4, wherein automatically adding image media to a print queue based on a social network interaction of a second user is determined by a social network subscription to a feed of the second user by the user.

7. The method of claim 1, wherein the print condition is based on a print count and time based parameters of collected image media.

8. The method of claim 1, wherein creating a deliverable print package includes exporting data that includes image data and shipment information.

9. The method of claim 8, wherein creating a deliverable print package includes printing image media and shipment packaging.

10. The method of claim 1, wherein creating a deliverable print package includes receiving location of the user; identifying a printing location according to the location of the user; and creating a deliverable print package at the identified printing location.

11. The method of claim 1, wherein creating a deliverable print package includes printing image media from the print queue; and further printing a digital link to a resource of the web service associated with the image media.

12. The method of claim 11, wherein creating a deliverable print package further includes printing the information associated with the image media with the printed image media.

13. The method of claim 12, further comprising retrieving the information associated with the image media data from the resource of the web service associated with the image media.

14. A method for distributing media comprising:
receiving a media file;
receiving parameter settings of an embeddable version of the media file;
creating an embeddable version of the media file with the parameter settings;
receiving a purchase command through the embeddable version; and
delivering media to a user associated with the received purchase command.

15. The method of claim 14, wherein the media file is a static image file.

16. The method of claim 14, wherein the media file is a video file.

17. The method of claim 14, further comprising analyzing a media file to authorize media for distribution by the owner.

18. The method of claim 14, wherein delivering media includes adding the media file to a print queue of the user associated with the received purchase command.

19. The method of claim 18, wherein the embeddable version of the media file includes a media view and a purchase interface element.

20. The method of claim 19, wherein the media file displayed in the media view may be updated through an admin control.

21. The method of claim 18, wherein delivering media further includes identifying a satisfying print condition and creating a deliverable print package.

22. The method of claim 21, wherein the parameter settings of an embeddable version includes supplemental media; and wherein creating a deliverable print package includes printing a representation of the media file and the supplemental media.

23. The method of claim 22, wherein the supplemental media is dynamically generated in the embeddable version while rendered in an outside page.

24. The method of claim 14, further comprising receiving embedding-page information through the embeddable version.
